(19) United States
(12) Patent Application Publication
(10) Pub. No.: US 2014/0126548 A1
(43) Pub. Date: May 8, 2014

(54) DYNAMIC PAGING CHANNEL SELECTION IN A MACHINE-TO-MACHINE WIRELESS WIDE AREA NETWORK

(71) Applicant: QUALCOMM INCORPORATED, San Diego, CA (US)

(72) Inventors: Bin TIAN, San Diego, CA (US); Alok K. GUPTA, San Diego, CA (US); Ahmad JALALI, Rancho Santa Fe, CA (US)

(73) Assignee: QUALCOMM Incorporated, San Diego, CA (US)

(21) Appl. No.: 13/669,327

(22) Filed: Nov. 5, 2012

(51) Int. Cl. H04W 72/04

(52) U.S. Cl. CPC H04W 72/04; H04W 72/0446
USPC 370/335; 370/329; 370/336; 370/337

(57) ABSTRACT

Methods, systems, and devices are described for managing wireless communications in a machine-to-machine (M2M) wireless Wide Area Network (WAN). A first paging message is transmitted in the M2M wireless at a first data rate using a first paging channel. An occurrence of a first event is detected. A second paging message is transmitted, based at least in part on the occurrence of the first event. The second paging message is transmitted at a second data rate using a second paging channel. The second paging channel being different from the first paging channel.

### BACKGROUND

The following relates generally to wireless communication, and more specifically to communications in a machine-to-machine (M2M) wireless wide area network (WAN). Wireless communications systems are widely deployed to provide various types of communication content such as voice, video, packet data, messaging, broadcast, sensor data, tracking data, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple devices. In some examples, these devices may be sensors and/or meters configured to collect data and transmit this data to an end server via a base station. These sensors and/or meters may be referred to as M2M devices. Base stations may communicate with M2M devices on forward and reverse links. Each base station has a coverage range, which may be referred to as the coverage area of the cell. A base station may transmit a paging message to an M2M device to inform the device that the base station is requesting the M2M device to contact the base station. Paging messages may be transmitted from the base station to the M2M device using a channel during a slot within a frame. The M2M device may monitor for paging messages and the base station may transmit the paging messages according to a paging cycle. The paging messages may be transmitted at a certain data rate using the channel. There may be instances where the data rate used to transmit the paging messages is too low for the intended device, so the device may remain awake longer than necessary. Transmitting at too low of a data rate may cause the device to use an unnecessary amount of power to remain awake and system capacity may not be fully utilized. Further, the M2M device may miss a paging message transmitted at the current data rate and must wait until the next paging cycle occurs to attempt to receive the paging message at the same data rate. If the same data rate continues to be used to transmit the paging message, the M2M device may be unable to successfully demodulate and decode the paging message.

### SUMMARY

The described features generally relate to one or more improved systems, methods, and/or apparatuses for dynamically selecting a paging channel in an M2M wireless WAN to change the data rate used to transmit a paging message. A paging slot may be included in a forward link frame. The paging slot may represent a time period of the frame where paging messages are transmitted to an M2M device. Paging messages may be transmitted in a paging channel during all or a portion of one or more paging slots. The paging channel may include one or more sub-channels. Paging messages may be transmitted in each sub-channel at different data rates. The M2M device may wake up to monitor a paging slot according to a paging cycle.

A base station may transmit a paging message during the paging slot according to the paging cycle. Paging messages may be transmitted to the M2M device during the paging slot using one or more of the sub-channels of the paging channel. To decrease the latency experienced by some M2M devices, and improve use of resources, the base station may transmit paging messages at a high data rate. If, however, an M2M device is unable to decode the message at such a high data rate, the device may not wake up again to monitor for a paging message until the next paging cycle. If the paging message continues to be transmitted at the high data rate, the device may continue to be unsuccessful at decoding the paging message. As a result, the device may remain unaware that the base station is requesting the M2M device to make contact. Dynamically changing the data rate by selecting a different sub-channel of the paging channel may increase the likelihood that the M2M device will successfully decode and demodulate the paging message.

In one embodiment, methods, systems, and devices are described for managing wireless communications in an M2M wireless WAN. A first paging message may be transmitted in the M2M wireless at a first data rate using a first paging channel. An occurrence of a first event is detected. A second paging message is transmitted, based at least in part on the occurrence of the first event. The second paging message is transmitted at a second data rate using a second paging channel. The second paging channel being different from the first paging channel.

In one configuration, the first paging message and the second paging message comprise a same message. The second data rate may be lower than the first data rate. In one embodiment, detecting the occurrence of the first event may include detecting a non-receipt of a response after a period of time following the transmission of the first paging message at the first data rate.

In one example, an occurrence of a second event may be detected, and a third paging message may be transmitted at the first data rate using the first paging channel. Detecting the occurrence of the second event may include detecting a receipt of a response indicating a receipt of the second paging message at the second data rate.

In one embodiment, the first paging channel and the second paging channel comprise a logical channel. The first paging message may be transmitted according to a first paging cycle, and the second paging message may be transmitted according to a second paging cycle. The first paging cycle may include a first length and the second paging cycle may include a second length. The second length may be shorter than the first length.

In one configuration, the first paging message may be retransmitted at the second data rate until a response is received indicating receipt of the first paging message. The first paging message and the second paging message may be transmitted concurrently. The transmission of the first paging message may use the first paging channel and the transmission of the second paging message may use the second paging channel.

Transmitting the first paging message and the second paging message may include transmitting the first paging message from a first base station, and transmitting the second paging message from the first base station. In one embodiment, transmitting the first paging message and the second paging message may include transmitting the first paging message from a first base station, and transmitting the second paging message from a second base station. The second base station may be different than the first base station.

In one embodiment, a time slot of a physical layer frame may be identified, and a paging message may be transmitted during the identified time slot. Identifying the time slot may include executing a hashing function to determine the time slot, and assigning the time slot to a terminal. The time slot may comprise the paging message.

In one configuration, the first paging channel and the second paging channel may comprise a code division multiple access (CDMA) channel. In one embodiment, the first paging channel and the second paging channel may comprise a time division multiple access (TDMA) channel.

A base station configured for wireless communication in an M2M wireless WAN is also described. The base station may include a processor and memory in electronic communication with the processor. Instructions may be stored in the memory. The instructions may be executable by the processor to transmit a first paging message in the M2M wireless WAN at a first data rate using a first paging channel, detect an occurrence of a first event, and transmit a second paging message, based at least in part on the occurrence of the first event, at a second data rate using a second paging channel. The second paging channel may be different from the first paging channel.

An apparatus configured for wireless communication in an M2M wireless WAN is also described. The apparatus may include means for transmitting a first paging message in the M2M wireless WAN at a first data rate using a first paging channel, and means for detecting an occurrence of a first event. The apparatus may further include means for transmitting a second paging message, based at least in part on the occurrence of the first event, at a second data rate using a second paging channel. The second paging channel may be different from the first paging channel.

A computer program product for managing wireless communication in an M2M wireless WAN is also described. The computer program product may include a non-transitory computer-readable medium storing instructions. The instructions may be executable by a processor to transmit a first paging message in the M2M wireless WAN at a first data rate using a first paging channel, and detect an occurrence of a first event. The instructions may be further executable by the processor to transmit a second paging message, based at least in part on the occurrence of the first event, at a second data rate using a second paging channel. The second paging channel may be different from the first paging channel.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 illustrates an example of a wireless communication system including a wireless wide area network (WAN) implementing M2M communications;

FIG. 3A shows a block diagram illustrating one embodiment of a paging system;

FIG. 3B is a block diagram illustrating one embodiment of a wireless communications system;

FIG. 4A is a block diagram illustrating a device for managing forward link communications in accordance with various embodiments;

FIG. 4B is a block diagram illustrating one embodiment of a forward link communications module;

FIG. 5A is a block diagram illustrating a device for managing reverse link communications in accordance with various embodiments;

FIG. 5B is a block diagram illustrating one embodiment of a reverse link communications module;

FIG. 6 is a block diagram illustrating a device for managing forward link communications in accordance with various embodiments;

FIG. 7 is a block diagram illustrating one embodiment of a paging channel selection module;

FIG. 8 illustrates one example of dynamically selecting different paging channels to transmit paging messages at different data rates and different paging cycles in accordance with the present systems and methods;

FIG. 9 shows a block diagram of a communications system that may be configured for dynamically altering a data rate at which paging messages are transmitted to M2M devices in accordance with various embodiments;

FIG. 10 is a flow chart illustrating one example of a method for managing forward link communications using multiple paging channels;

FIG. 11 is a flow chart illustrating one example of a method for managing forward link communications through dynamic selection of paging channels of a paging slot; and

FIG. 12 is a flow chart illustrating one example of a method for managing forward link communications by implementing a dynamic selection of a paging channel for the transmission of paging messages.

### DETAILED DESCRIPTION

Methods, systems, and devices are described to dynamically change paging channels used in a wireless M2M WAN to transmit paging messages to an M2M device. In one embodiment, M2M devices may monitor a paging slot of a forward link frame to detect a paging message. If a paging message is present in the paging slot, it may indicate to the M2M device that a base station is requesting the M2M device to contact the base station. Upon detecting and demodulating a paging message, the M2M device may contact the base station to engage in further communications. Currently, paging messages may be transmitted to each M2M device in the wireless M2M WAN at a low data rate. Transmitting the messages at a low data date may increase the likelihood that M2M devices in the network with a lower signal strength (e.g., devices that are located at a greater distance from the base station) will be able to properly decode the message. This approach, however, may unnecessarily increase the latency for M2M devices that have a strong signal strength and could receive messages at a higher data rate. For example, the signal strength between the base station and some of the M2M devices may be strong enough to support a successful transmission of a paging message at a high data rate. Moreover, system capacity may not be fully utilized.

In one configuration, M2M devices may constantly be in an awake mode to monitor the paging slot of each frame transmitted on a forward link. This approach, however, causes the M2M devices to consume a high level of power to remain in the awake mode. An alternative approach is for the M2M devices to periodically wake up to monitor a paging slot based on a paging cycle. If a paging message is not transmitted during the monitored paging slot, a device may return to a sleep mode until the next paging cycle. To decrease latency with this approach, paging messages may be transmitted at a high data rate at a long duty cycle. For example, paging messages may be transmitted at a high data rate every 5 minutes. In some cases, however, an M2M device may unable to demodulate the message transmitted at the high data rate. As a result, the M2M device will return to the sleep mode and wait until the next paging cycle to attempt to demodulate the message. If the paging message continues to be transmitted at this high data rate at the next paging cycle, the M2M device may still be unable to decode the message and will remain unaware that the base station is requesting the M2M device to make contact.

Paging messages may be transmitted in a paging channel at a certain data rate. In one configuration, messages may be transmitted using one or more sub-channels of the paging channel. Paging messages may be transmitted in different sub-channels at different data rates and at different paging cycles. For example, a base station may transmit a first paging message in a first sub-paging channel (hereinafter a “first paging channel”) at a first data rate and at a first paging cycle. The base station may also transmit a second paging message in a second sub-paging channel (hereinafter a “second paging channel) at a second data rate and at a second paging cycle. In some instances, the first paging message and the second paging message may be the same. The message may be transmitted in the first and second paging channels at different data rates and at different duty cycles. In one embodiment, the paging message may be transmitted at a lower data rate on the second channel and more frequently than the message transmitted in the first paging channel at a higher data rate.

In one embodiment, a paging message may be initially transmitted at a high data rate to an M2M device using a first paging channel at a long duty cycle. If the device is unsuccessful at demodulating the message, the message may be retransmitted at a lower data rate using a second paging channel at a short duty cycle. When the M2M device successfully demodulates the paging message at the low data rate, the base station may return to transmit future paging messages on the first channel at the high data rate and at the long duty cycle.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

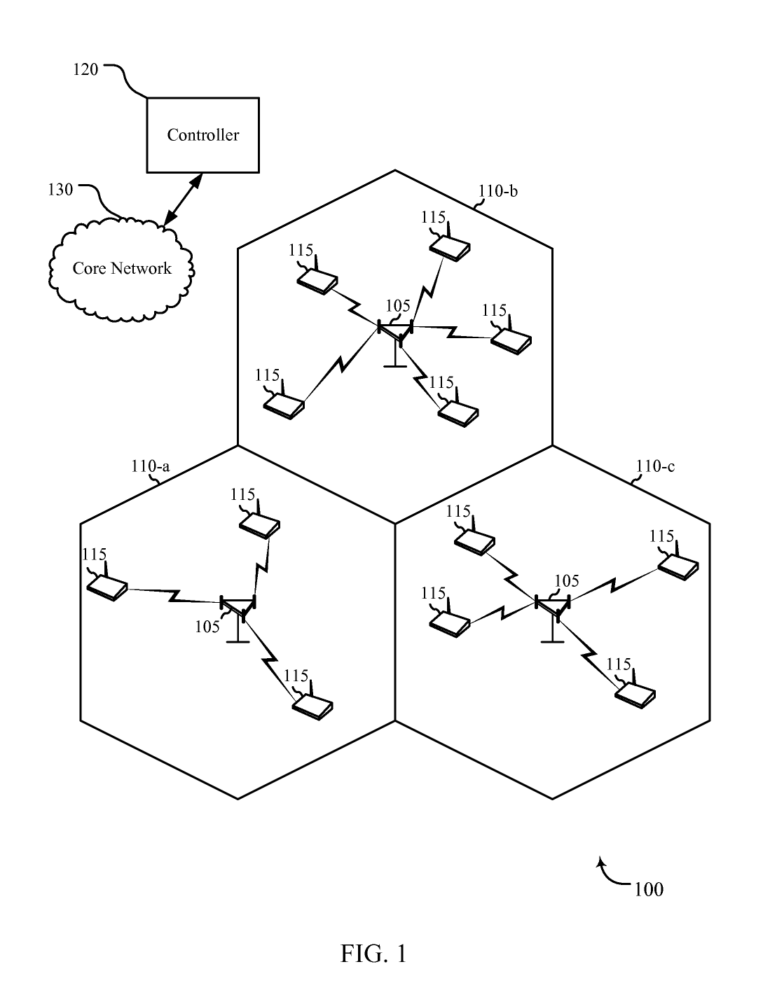

Referring first to FIG. 1, a block diagram illustrates an example of a wireless communications system 100. The system 100 includes base stations 105 (or cells), machine-to-machine (M2M) devices 115, a base station controller 120, and a core network 130 (the controller 120 may be integrated into the core network 130). The system 100 may support operation on multiple carriers (waveform signals of different frequencies).

The base stations 105 may wirelessly communicate with the M2M devices 115 via a base station antenna (not shown). The base stations 105 may communicate with the M2M devices 115 under the control of the base station controller 120 via multiple carriers. Each of the base station 105 sites may provide communication coverage for a respective geographic area. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, pico, and/or femto base stations). A macro base station may provide communication coverage for a relatively large geographic area (e.g., 35 km in radius). A pico base station may provide coverage for a relatively small geographic area (e.g., 10 km in radius), and a femto base station may provide communication coverage for a relatively smaller geographic area (e.g., 1 km in radium). There may be overlapping coverage areas for different technologies.

The M2M devices 115 may be dispersed throughout the coverage areas 110. Each M2M device 115 may be stationary or mobile. In one configuration, the M2M devices 115 may be able to communicate with different types of base stations such as, but not limited to, macro base stations, pico base stations, and femto base stations. The M2M devices 115 may be sensors and/or meters that monitor and/or track other devices, environmental conditions, etc. The information collected by the M2M devices 115 may be transmitted across a network that includes a base station 105 to a back-end system, such as a server. The transmission of data to/from the M2M devices 115 may be routed through the base stations 105. The base stations 105 may communicate with the M2M devices on a forward link. In one configuration, the base stations 105 may generate a forward link frame with a number of time slots that include channels to carry data and/or messages to an M2M device 115. In one example, each forward link frame may include no more than three time slots and corresponding channels. These slots and channels may include a paging slot with a paging channel, an ACK slot with an ACK channel, and a traffic slot with a traffic channel. The length of an individual frame may be short (e.g., 20 milliseconds (ms)). In one embodiment, four frames may be joined to form a larger frame with a duration of 80 ms. Each frame included in the larger frame may include no more than three time slots and channels such as the paging slot for the paging channel, the ACK slot for the ACK channel, and the traffic slot for the traffic channel. The slots for the paging and ACK channels of each frame may each have a length of 5 ms while the traffic slot for the traffic channel of each frame may have a length of 10 ms. An M2M device 115 may wake up and monitor only the individual frames (within the larger frame) that include data and/or messages on its channels that are intended for that M2M device 115.

In one configuration, M2M devices 115 may wake up periodically to monitor the time slots of a frame. For example, a device may periodically wake up to monitor a paging slot of a frame. The device may wake up according to a paging cycle. For instance, an M2M device 115 may wake up every 5 minutes to monitor the paging slot of a frame. The base station 105 may also be aware of the paging cycle and may transmit paging messages (when they exist) during paging slots of frames according to the paging cycle. A paging message may be transmitted during the paging slot to request the M2M device 115 to contact the base station 105 to report the current status of the device 115, to prepare to receive data from the base station 105, or for other purposes. If the device 115 does not demodulate the paging message during the monitored paging slot, the device 115 (in this example) may then return to a sleep mode until 5 minutes has lapsed, after which the device 115 may wake up to again monitor the paging slot. This causes the M2M device 115 to remain unaware that the base station 105 has a need to contact the M2M device 115.

In one configuration, when the M2M device 115 successfully demodulates a paging message, a paging response may be transmitted back to the base station 105. When the base station 105 does not receive this response, the data rate used to transmit the paging message may be lowered to increase the likelihood that the M2M device 15 will be able to successfully demodulate the paging message. In addition, the transmission frequency of this message at the lower data rate may be increased. For example, the paging message may initially be transmitted in a first paging channel at a high data rate. If the M2M device 115 is unable to demodulate the message at this data rate, the base station 105 will not receive a response from the M2M device 115 indicating a successful demodulation of the message. The base station 105 may dynamically lower the data rate by retransmitting the message in a second paging channel. The retransmission of the paging message at the lower data rate may occur more frequently (e.g., shorter duty cycle) until the base station 105 receives a response, until a predetermined time period, or until a number of retransmissions has occurred. In one example, instead of waking up ever 5 minutes to monitor the paging slot, the device 115 may now wake up 2 seconds to monitor for paging messages sent at a lower data rate on the second paging channel. These changes also affect the base station. In one embodiment, the base station 105 will now transmit the paging message using a second paging channel at a lower data rate to this device every 2 seconds (instead of every 5 minutes). By lowering the data rate, M2M devices that do not possess the necessary signal strength may still be able to decode the paging messages, while M2M devices that have sufficient signal strength may receive the messages with a shorter latency because they are transmitted at high data rate. By shortening the paging cycle, the M2M device 115 does not need to wait for another 5 minutes for an opportunity to demodulate the paging message. This may reduce the delay before the M2M device 115 is aware that the base station 105 has a need to contact the device 115.

In one embodiment, M2M devices 115 may be incorporated in other devices or the M2M devices 115 may be standalone devices. For example, devices such as cellular phones and wireless communications devices, personal digital assistants (PDAs), other handheld devices, netbooks, notebook computers, surveillance cameras, handled medical scanning devices, home appliances, etc. may include one or more M2M devices 115.

In one example, the network controller 120 may be coupled to a set of base stations and provide coordination and control for these base stations 105. The controller 120 may communicate with the base stations 105 via a backhaul (e.g., core network 125). The base stations 105 may also communicate with one another directly or indirectly and/or via wireless or wireline backhaul.

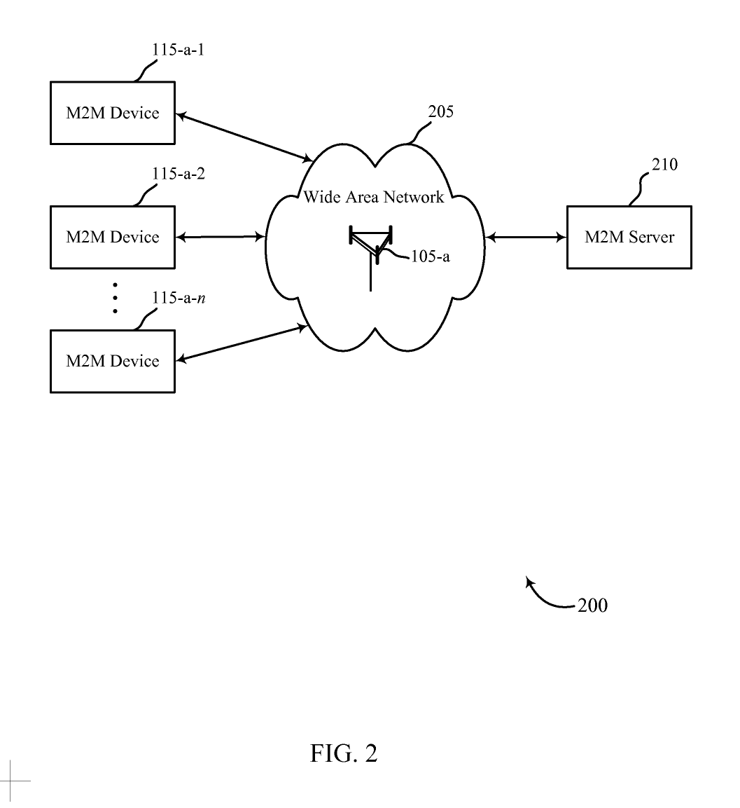

FIG. 2 illustrates an example of a wireless communication system 200 including a wireless wide area network (WAN) 205 implementing an M2M service according to one aspect. The system 200 may include a number of M2M devices 115-a and an M2M server 210. Communications between the server 210 and M2M devices 115 may be routed through a base station 105, that may be considered part of the WAN 205. The base station 105-a may be an example of the base stations illustrated in FIG. 1. The M2M devices 115-a may be examples of the M2M devices 115 illustrated in FIG. 1. One skilled in the art would understand that the quantity of M2M devices 115-a, WANs 205, and M2M servers 210 shown in FIG. 2 is for illustration purposes only and should not be construed as limiting.

The wireless communication system 200 may be operable to facilitate M2M communications. M2M communications may include communications between one or more devices without human intervention. In one example, M2M communications may include the automated exchange of data between a remote machine, such as an M2M device 115-a, and a back-end IT infrastructure, such as the M2M server 210, without user intervention. The transfer of data from an M2M device 115-a to the M2M server 210 via the WAN 205 (e.g., the base station 105-a) may be performed using reverse link communications. Data collected by the M2M devices 115-a (e.g., monitoring data, sensor data, meter data, etc.) may be transferred to the M2M server 210 on the reverse link communications.

The transfer of data from the M2M server 210 to an M2M device 115-a via the base station 105-a may be performed via forward link communications. The forward link may be used to send instructions, software updates, and/or messages to the M2M devices 115-a. The instructions may instruct the M2M devices 115-a to remotely monitor equipment, environmental conditions, etc. M2M communications may be used with various applications such as, but not limited to, remote monitoring, measurement and condition recording, fleet management and asset tracking, in-field data collection, distribution, and storage, etc. The base station 105-a may generate one or more forward link frames with a small number of time slots with channels to transmit instructions, software updates, and/or messages. The various M2M devices 115-a may wake up to monitor the time slots of a specific frame when instructions or other data is included on a channel during the time slots of that frame. The devices 115-a may become aware that instructions or other data are available by decoding a paging message during a paging slot of a frame. A paging cycle may indicate how often the base station 105-a should transmit a paging message to an M2M device 115-a. The device 115-a may wake up to monitor a paging slot for a paging message according to the paging cycle. The paging messages may be transmitted at different data rates based on a transmission schedule. In one embodiment, the base station 105-a may be unaware of the strength of the signal of the device 115-a. The base station 105-a may first attempt to transmit a paging message at a high data rate and then switch to a lower data rate if no paging response is received from the device 115-a indicating that the paging message was received at the high data rate.

In one configuration, different types of M2M communications may be proposed in different wireless access networks that use different addressing formats. Different addressing formats may lead to different types of M2M devices 115-a being used for different services. In one aspect, an M2M network may be implemented which may maintain the M2M devices 115-a independent of the WAN technology that is used to communicate with the M2M server 210. In such an aspect, the M2M devices 115-a and the M2M server 210 may be made independent of the WAN technology that is used. As a result, a WAN technology used for backhaul communication may be replaced with a different WAN technology, without affecting the M2M devices 115-a that may already be installed. For example, the M2M server 210 and an M2M device 115-a may communicate with each other irrespective of the addressing format used by the WAN technology since the addressing format used by the M2M device 115-a may not be tied with the addressing used by the implemented WAN technology.

In one embodiment, the behavior of the M2M devices 115-a may be pre-defined. For example, the day, time, etc. to monitor another device and transmit the collected information may be pre-defined for an M2M device 115-a. For example, the M2M device 115-a-1 may be programmed to begin monitoring another device and collect information about that other device at a first pre-defined time period. The device 115-a-1 may also be programmed to transmit the collected information at a second pre-defined time period. The behavior of an M2M device 115-a may be remotely programmed to the device 115-a. Data rates and duty cycles used to transmit paging messages may be flexible depending on various conditions. Details regarding dynamically changing data rates used to transmit paging messages will be described below.

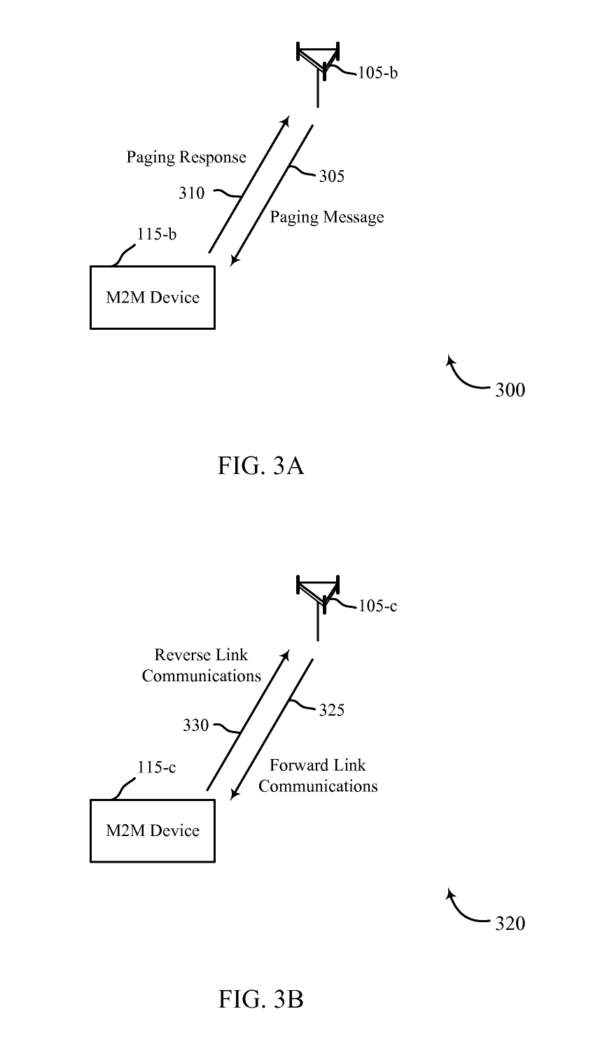

FIG. 3A is a block diagram illustrating one embodiment of a paging system 300 including a base station 105-b and an M2M device 115-b. The base station 105-b may be an example of the base stations 105 of FIG. 1 or 2. The M2M device 115-b may be an example of the M2M devices 115 of FIG. 1 or 2.

In a wireless communication system, such as the systems of FIG. 1 or 2, the notions of sleep state and paging are important to provide network connectivity to a large population of devices (e.g., M2M devices 115) in a battery power and air link resource efficient manner. A sleep state may provide the M2M device 115-b with a mode of operation to minimize battery power consumption by shutting down the whole or a part of the devices' transmit/receive circuitry. In addition, an M2M device 115 in the sleep state may not be allocated any dedicated air link resource and therefore a large number of M2M devices may be simultaneously supported. During time intervals where the M2M device 115-b has no traffic activity, the device 115-b may remain in the sleep state to conserve resources.

Paging may involve the M2M device 115-b waking up periodically from the sleep state, and having the M2M device 115-b operate to receive and process a paging message 305 in the forward link communications (e.g., communications from the base station 105-b to the M2M device 115-b). The base station 105-b may be aware when the M2M device 115-b should wake up. Thus, if the base station 105-b intends to contact, or page, the M2M device 115-b, the base station 105-b may send the paging message 305 in a paging channel during all or a portion of one or more paging slots of a forward link frame at the time when the M2M device 115-b is scheduled to wake up and monitor the paging channel. The base station 105-b, however, may not be aware of the signal strength of each M2M device 115 in the M2M wireless WAN. As a result, the base station 105-b may transmit paging messages at a high data rate using a first paging channel. If the M2M device 115-b is unable to properly demodulate the paging message 305 because the signal strength of the device 115-b is too low, the base station 105-b may dynamically change the data rate used to transmit the message to the device 115-b. In addition, the base station 105 may increase the frequency it transmits the paging message 305 and the device 115-b may increase the frequency it wakes up to monitor for the paging message 305 sent at the lower data rate. In one configuration, if the base station 105-b does not receive a paging response 310 confirming that the M2M device 115-b has received the paging message, the base station 105-b may retransmit the paging message 305 on a second paging channel during the paging slot more frequently and at a lower data rate. The base station 105-b may retransmit the paging message 305 until either the M2M device 115-b receives the paging message 305 and transmits a paging response 310 and/or a certain number of transmissions of the paging message 305 have occurred. If one or both of these events occur, the base station 105-b and the M2M device 115-b may return to operate under the previous paging cycle and the base station 105-b may return to transmit paging messages to the device 115-b at a high data rate using the first paging channel.

The time interval between two successive wake-up periods of an M2M device 115-b may be referred to as a paging cycle. The M2M device 115-b may operate in a sleep state during the portion of the paging cycle when the M2M device 115-b is not performing processing related to receiving a paging message 305. In order to maximize the benefit of the sleep state, the paging system 300 may use a large value for the paging cycle. For example, in a data system, the paging cycle may be about 5 minutes. As mentioned above, if the base station 105-b does not receive the paging response 310 indicating the successful receipt of the paging message 305, the base station 105-b may retransmit the paging message 305 using a smaller paging cycle until the paging response 310 is received. The retransmission of the paging message 305 may occur using the same channel or a different channel. Further, the M2M device 115-b may wake up more periodically (i.e., shorter paging cycle) to monitor paging slots of frames for the paging message 305.

In one embodiment, the paging channel used during the paging slot of a frame may have sufficient bandwidth to carry a number of paging messages 305. In one example, the paging channel may carry less than the maximum amount of paging messages 305. The base station 105-b may insert system information into the extra, unused bandwidth of the paging channel during the paging slot. The system information may be used by a number of M2M devices 115 to acquire the timing of the signals transmitted from the base station 105-b. Reusing the paging channel to transmit system information avoids the need to set up additional channels during additional time slots of the forward link frames to carry such information (which may increase the overall length of a forward link frame). As a result, M2M devices 115 may conserve power by minimizing the amount of time they are in an awake mode. By reusing the paging channel, the time slots of the frames transmitted on the forward link may be kept short, allowing the M2M devices 115 to return to the sleep mode as quickly as possible.

Upon receiving the paging message 305, the M2M device 115-b may carry out any operations specified in the paging message 305. For example, the M2M device 115-b may just receive the paging message 305 and go back to the sleep state. Alternatively, the M2M device 115-b may access the base station 105-b to establish an active connection with the base station 105-b.

FIG. 3B is a block diagram illustrating one embodiment of a wireless communications system 320. The system 320 may include a base station 105-c and an M2M device 115-c. The base station 105-c and the M2M device 115-c may be examples of the base stations and M2M devices of FIG. 1, 2, or 3A. In one configuration, the base station 105-c may communicate with the M2M device 115-c using a forward link frame with a limited number of time slots for logical channels used for forward link communications 325. The M2M device 115-c may communicate with the base station 105-c using reverse link communications 330. Communications that occur using the forward and reverse link communications may be M2M communications, as described above. These communications may take various forms, depending principally on the air interface protocol used by the base station 105-c and the M2M device 115-c.

The base station 105-c may be arranged to communicate on one or more carrier frequencies, typically using a pair of frequency bands to define the forward and reverse links communications, respectively. The base station 105-c may also include a set of directional antenna elements arranged to define multiple cell sectors. M2M communications in each sector on a given carrier frequency may be distinguished from communications in other sectors by modulating the communications in the given sector with a sector-specific code, such as a pseudo-random noise offset (“PN offset”). Further, M2M communications in each sector may be divided into control and traffic channels, each of which may be defined through time division multiplexing (TDM).

In one embodiment, signals may be transmitted on the forward link communications 325 and the reverse link communications 330 in a frame format. Within the frame format, information may be packetized and formatted according to the actual payload data to be communicated over the communication links 325, 330. In one configuration, the format of a frame transmitted on the forward link communications 325 may include various time slots for various channels. In one embodiment, the frame may include a paging slot for the paging channel, an ACK slot for the ACK channel, and a traffic slot for the traffic channel. As mentioned above, paging messages 305 and/or system information may be transmitted in the paging channel (according to the paging cycle) to the M2M device 115-c during a paging slot. ACK message may be transmitted in the ACK channel to an M2M device during the ACK time slot when a signal is successfully received at the base station 105-c. Traffic data may be transmitted in the traffic channel to the M2M device 115-c during the traffic time slot. Frames used on the forward link communications 325 in M2M communications may be based on a short duty cycle.

To conserver power, an M2M device 115 may wake up only during specific time slots of specific forward link frames to receive data, paging messages 305, etc. As a result, the frame structure in M2M communications may be slotted for each M2M device. For example, a first frame may include a first paging slot (for a first paging channel) that carries paging messages and other information intended for a first M2M device 115. A second, third, and fourth frame may include a second, third, and fourth paging slot, respectively. A second, third, and fourth M2M device may receive messages and data on these slots, respectively. In one embodiment, the M2M device 115-c may use a set of hashing functions on its identification (ID), on the number of slots at the expected data rate, and on a total number of users at the expected data rate to determine the slot where the device 115-c can expect to receive its data. Thus, each device 115 may only be required to wake up for the slot of the frame that is needed to retrieve its data. Each device 115 may wake up according to its paging cycle to monitor a paging slot for paging messages. The paging messages may be transmitted at a first data rate according to a first paging cycle. If certain conditions change, the data rate and paging cycle may dynamically change. For example, the data rate may be lowered and the cycle may be shortened. As a result, the device 115 may wake up more frequently to monitor the paging slots for paging messages transmitted at a lower data rate. The data rate may be lowered and the paging cycle may be shortened if the device 115 is unable to successfully decode a paging message at the original data rate and paging cycle. In addition, the data rate and/or the paging cycle may change based on various environmental conditions, the time of day, the available bandwidth on the forward link communications 325, the state of the M2M device 115, etc. Dynamically changing the paging cycle and data rate may allow the M2M device 115 to demodulate a paging message 305 at an earlier time instead of waiting until the next, longer paging cycle expires to wake up to monitor for a paging message 305.

In one configuration, to preserve communication resources, the M2M device 115-c may perform opportunistic decoding of a message transmitted from the base station 105-c in order to return to the sleep state, according to the present systems and methods. In one embodiment, the base station 105-c may generate one or more forward link frames and transmit multiple copies of a message to the M2M device 115-c using a channel of the one or more forward link frames. Each copy of the message may be sent in a sub-channel at a high data rate. The M2M device 115-c may read as many copies of the message as are needed to successfully demodulate the message. In one configuration, the M2M device 115-c may estimate the number of copies of the message it needs to receive to decode the message based on the received signal strength from a pilot signal transmitted from the base station 105-c. Upon successfully decoding the message, the device 115-c may return to a sleep state before generating and transmitting an physical layer ACK message back to the base station 105-c. If additional copies of the message remain in the sub-channels, the base station 105-c may continue to transmit the additional copies (even though the M2M device 115-c has returned to the sleep state). In one configuration, the device 115-c may conserve battery power by not transmitting the physical layer ACK message to the base station indicating that the message has been received.

In one embodiment, the reverse link communications 330 may be terminated early to conserve the battery power of the M2M device 115-c and air interface resources between the M2M device 115-c and the base station 105-c. As stated above, a forward link frame may include an ACK channel. The base station 105-c may use the ACK channel to carry ACK messages that acknowledge the reception of a reverse link physical layer packet sent from the M2M device 115-c using the reverse link communications 330. In one configuration, ACKs corresponding to higher reverse link data rates may be transmitted at higher forward link data rate from the base station 105-c to the M2M device 115-c. ACKs corresponding to lower reverse link data rates may be transmitted at lower forward link data rates. As a result, rather than sending each ACK at the lowest data rate, it may be sent at different data rates, resulting in at least two different packet formats. When ACKs are transmitted at higher data rates to the M2M device 115-c, the device 115-c may receive and decode the ACK more quickly, thus increasing the forward link ACK throughput and terminating the reverse link communications 330 at an earlier time period than if the ACK was transmitted using a low data rate.

In one configuration, the operating band of the reverse link communications 330 may be divided into multiple reverse link frequency channels. Within each frequency channel, CDMA techniques may be used to multiplex the reverse link communications for multiple M2M devices 115. In one example, each reverse link frequency channel may have its own rise over thermal (ROT) operation point. At least one frequency channel may be dedicated as a low data rate random access channel. Dividing the operating band of the reverse link communications 330 may provide a low ROT operation target (e.g., 1 decibel (dB) or less) for reverse link communications. A low ROT may reduce the link budget requirement for those devices in locations with large path loss.

In one example, to increase the power efficiency of the M2M device 115-c, a narrowband frequency-division multiple access (FDMA) technique may be used for the reverse link communications 330. This technique may include dividing the operating band of the reverse link communications 330 into a number of narrowband frequency channels. The base station 105-c may broadcast the status and assignment of each narrowband channel to each M2M device 115. The status may be “busy” or “idle”. In one embodiment, the M2M device 115-c may only transmit data if a narrowband frequency channel is assigned to the device 115-c. The early termination of the reverse link communications 330 (described above) may be incorporated into the narrowband FDMA technique to exploit the signal-to-interference noise ratio (SINR) distribution and to support multiple data rates in the reverse link communications 330.

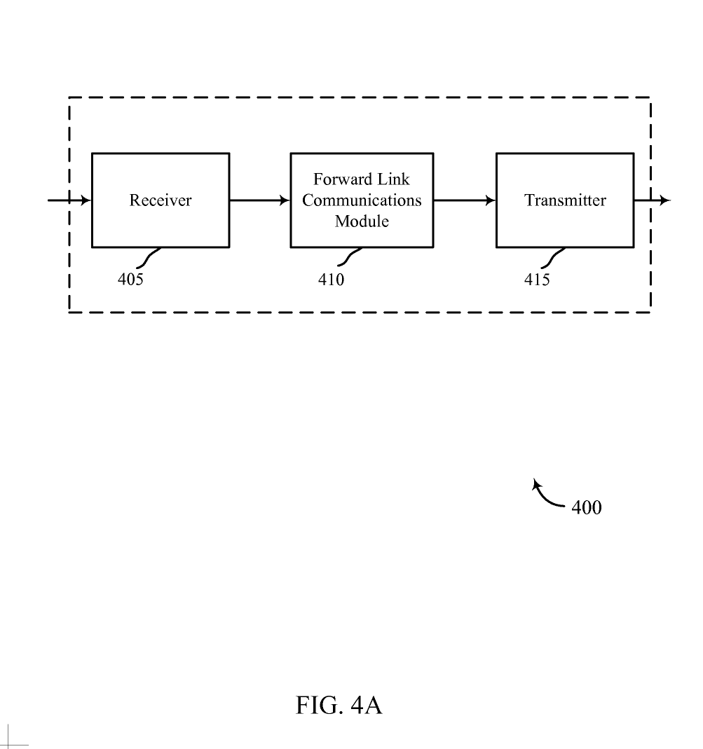

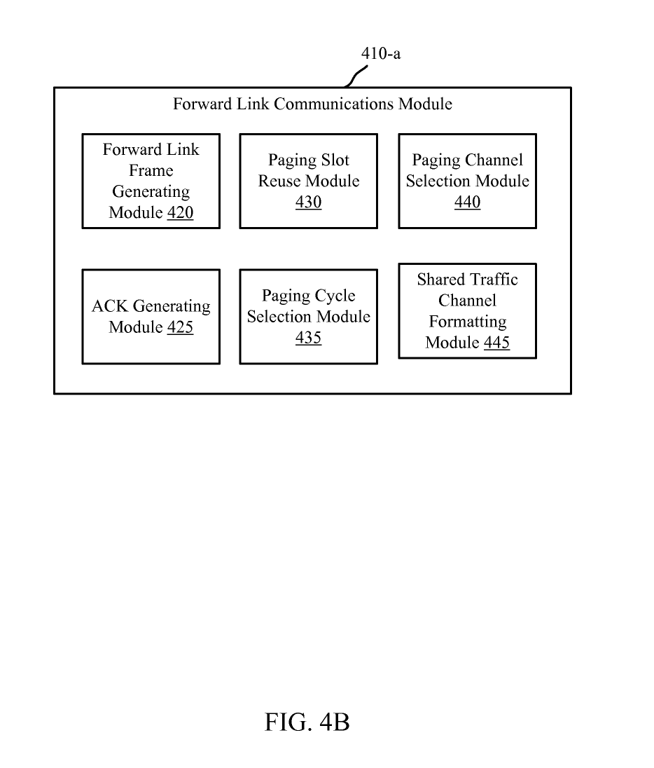

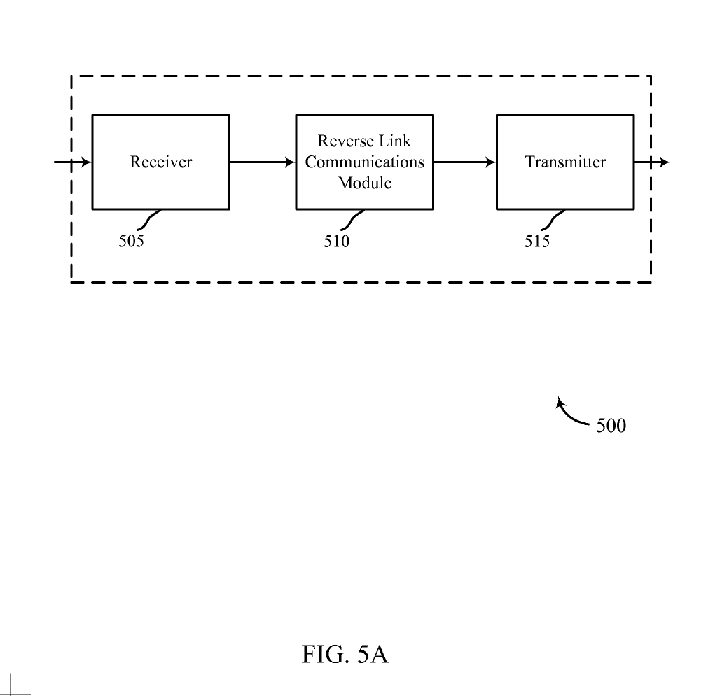

Turning next to FIG. 4A, a block diagram illustrates a device 400 for managing forward link communications in accordance with various embodiments. The device 400 may be an example of one or more aspects of base stations 105 described with reference to FIGS. 1, 2, 3A, and/or 3B. The device 400 may also be a processor. The device 400 may include a receiver module 405, a forward link communications module 410, and/or a transmitter module 415. Each of these components may be in communication with each other.

These components of the device 400 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may receive information such as packet, data, and/or signaling information regarding what the device 400 has received or transmitted. The received information may be utilized by the forward link communications module 410 for a variety of purposes.

The receiver module 405 may be configured to receive a reverse link physical layer packet sent from an M2M device 115 using reverse link communications 330. The receiver module 405 may also be configured to receive instructions, a set of operations, messages, etc. from a back-end server to communicate to an M2M device 115. The forward link communications module 410 may generate one or more forward link frames. The frames may be short duty cycle frames that include a minimal number of time slots used for logical channels. The forward link frames may be slotted for communications with multiple M2M devices. Details regarding the forward link frame will be described below.

The forward link communications module 410 may generate an ACK message indicating a packet has been successfully received on the reverse link 330. The transmitter module 415 may be configured to transmit the ACK message in the forward link frame to the M2M device 115. Instead of transmitting the ACK channel in the forward link frame at the lowest data rate, it may be transmitted at a higher data rate, resulting in early termination of communications received on the reverse link 330 by the receiver 405, as previously described.

In one embodiment, the forward link communications module 410 may generate a number of paging messages 305 to transmit to a number of M2M devices 115 via the transmitter module 415. The paging messages 305 may alert specific M2M devices 115 that a base station 105 is requesting the M2M device 115 to make contact with the base station 105. In one configuration, paging messages 305 may be transmitted in the paging channel (or a sub-channel of the paging channel) during the paging time slot at different data rates, depending on whether the M2M device 115 successfully demodulates a paging message. In one configuration, the paging channel may include less than the maximum number of paging messages 305. If the paging channel does not include the maximum number of paging messages 305, the paging slot may be determined to idle. The unused capacity of the paging channel may be utilized by inserting system information into the paging channel. The system information may then be broadcast to the M2M devices 115 in the paging channel during the paging time slot of the forward link frame. Additional channels and time slots are avoided in forward link frames to transmit this type of information. Instead, idle paging time slots may be reused to transmit system information.

The receiver module 405 may receive a paging response 310 when the M2M device 115 successfully decodes the paging message 305. When the receiver module 405 does not receive the paging response 310, the forward link communications module 410 may be configured to instruct the transmitter module 415 to retransmit the paging message 305. The transmitter module 415 may retransmit the message 305 at a lower data rate and at a higher frequency than the original transmission of the paging message 305. The transmitter module 415 may cease the retransmission when a paging response 310 is received by the receiver module 405 and/or after a certain number of retransmissions of the message 305 have been transmitted. The transmitter module 415 may transmit and retransmit the paging messages 305 on different sub-paging channels of different forward link frames. In one configuration, when the paging channel is not needed to transmit a paging message 305, the forward link communications module 410 may generate and insert system information into the paging channel of the forward link frame. The transmitter module 415 may transmit the system information to an M2M device 115 in the paging channel of the frame. In one configuration, the transmitter 415 may transmit information using multiple paging channels of multiple frames. Paging messages may be transmitted in different paging channels at different data rates and at different paging cycles.

FIG. 4B is a block diagram illustrating one embodiment of a forward link communications module 410-a. The module 410-a may be an example of the forward link communications module of FIG. 4A. In one example, the module 410-a may include a forward link frame generating module 420, an ACK generating module 425, a paging slot reuse module 430, a paging cycle selection module 435, a paging channel selection module 440, and a shared traffic channel formatting module 445.

The forward link frame generating module 420 may generate a physical layer frame to be used for communications on the forward link 325 (e.g., from a base station to an M2M device). The generated frame may be based on a short duty cycle and a small number of slotted physical layer channels. For example, the module 420 may generate a forward link physical layer frame that is a total of 20 milliseconds (ms). As a result, an M2M device 115 may only need to wake up for 20 ms to receive the forward link frame. Thus, power may be conserved at the M2M device 115. The slotted operation of the frame generated by the module 420 may allow the M2M device 115 to wake up and turn on its radio only during the scheduled time slot of the frame where it is expecting data. As a result, the M2M device 115 may be in the awake mode for less than the length of the frame.

Each of the physical channels of the forward link frame may include both pilot symbols and data symbols, which may be time division multiplexed (TDM). In one configuration, a forward link frame generated by the module 420 may include a paging slot, an ACK slot, and a traffic slot. Paging messages and other information may be transmitted in a paging channel to an M2M device 115 on the forward link communications 325 during the paging time slot. ACK messages and additional information may be transmitted in an ACK channel during the ACK slot. Data messages may be transmitted in a traffic channel to an M2M device 115 during the traffic slot.

The ACK generating module 425 may generate an ACK message to transmit on the forward link communications 325. The message may be transmitted on an ACK channel that is part of the forward link frame generated by the forward link frame generating module 420. In one configuration, the forward link frame may be used to transmit a compressed identification (ID) to an M2M device 115. The compressed ID may be a hash of the network ID of the M2M device 115. The compressed ID may represent an ACK message for the M2M device 115 indicating that the base station successfully received a packet transmitted from the M2M device on the reverse link. In one configuration, the ACK generating module 425 may group the compressed ID for one M2M device together with compressed IDs of other M2M devices to create an ACK packet. ACK packets may include different quantities of compressed IDs.

In some instances, a paging slot may be idle for a certain forward link frame. For example, the capacity of the paging channel during the paging slot may not be at full capacity. For instance, the paging slot may not be scheduled to transmit a paging message 305 for an M2M device 115. As a result, the paging channel may be empty (e.g., no paging messages 305). The paging slot reuse module 430 may reuse the idle paging slot to communicate system information to the M2M device 115. The system information may include system timing and sector number information and may be inserted into the paging channel for transmission to the M2M devices 115 during the paging time slot. Thus, the establishment of additional channels within the forward link frame to convey the system information to an M2M device 115 may be avoided. Instead, the paging slot reuse module 430 may insert the system information in an idle paging channel of the paging slot in the frame.

In one embodiment, the paging cycle selection module 435 may select a particular paging cycle to transmit paging messages to an M2M device. The module 435 may provide a flexible paging scheme to dynamically change the paging cycle for an M2M device 115 in an M2M wireless WAN. The paging cycle selection module 435 may dynamically change the paging cycle depending on whether a paging response 310 is received from the device 115, the time of day, the state of operation of the M2M device 115, etc.

In one configuration, the paging channel selection module 440 may select between sub-channels of the paging channel to transmit a paging message to an M2M device 115 using the forward link communications 325. For example, the selection module 440 may select between a primary and secondary paging channel. The module 440 may provide a paging scheme that allows for paging messages to be transmitted at different data rates in an M2M WAN using primary and secondary paging channels. The primary paging channel may be used for longer paging cycles while the secondary paging channel may be used for shorter paging cycles. In one example, a base station 105 may transmit a first paging message. The module 440 may select the primary channel. The first paging message may be transmitted in the primary channel at a high data rate over a long paging cycle. The base station may also transmit a second paging message. The module 440 may select the secondary paging channel. The second paging message may be transmitted in the second paging message since the second message is to be transmitted at a lower data rate over a shorter paging cycle. In one embodiment, the first and second paging messages may be the same. In one example, the paging channels may be logical channels. In one configuration, the paging channels may be code division multiple access (CDMA) channels. In one example, the paging channels may be time division multiple access (TDMA) channels.

The shared traffic channel formatting module 445 may format a traffic channel in the forward link frame that may be shared by multiple M2M devices. When a M2M device 115 is expecting data on a shared traffic channel within a given traffic channel cycle, the device 115 may continue reading the traffic channel slots across multiple forward link frames during a traffic channel cycle until it finds its data as indicated by the ID field. As a result, the M2M device 115 may stay awake longer than necessary to find its data. The formatting module 445 may format the traffic channel in such a way so as to minimize the wake up time for the M2M device 115. The M2M device 115 may determine which slot of a particular frame to wake up in order to get its data on the shared traffic channel. To determine which slot to wake up for, the M2M device may use a set of hashing function on its ID. The M2M device may also use the number of slots at the expected data rate and the total number of users at that rate to determine the slot where it can expect to receive its data. The traffic channel may be formatted by the module 445 to allow the device to determine which slot to use. For example, the module 445 may format the shared traffic channel so that the hashed slot either contains the data or a pointer to a slot where the actual data is located. If a slot of a first frame cannot contain all the pointers, the module 445 may set an overflow flag and provide a pointer to another slot of another frame where the hashed M2M device can check for its data. If all the data for the M2M device 115 cannot be accommodated during a single slot, then the module 445 may format a trailer field of the channel to include a pointer to another slot where the remaining data is transmitted.

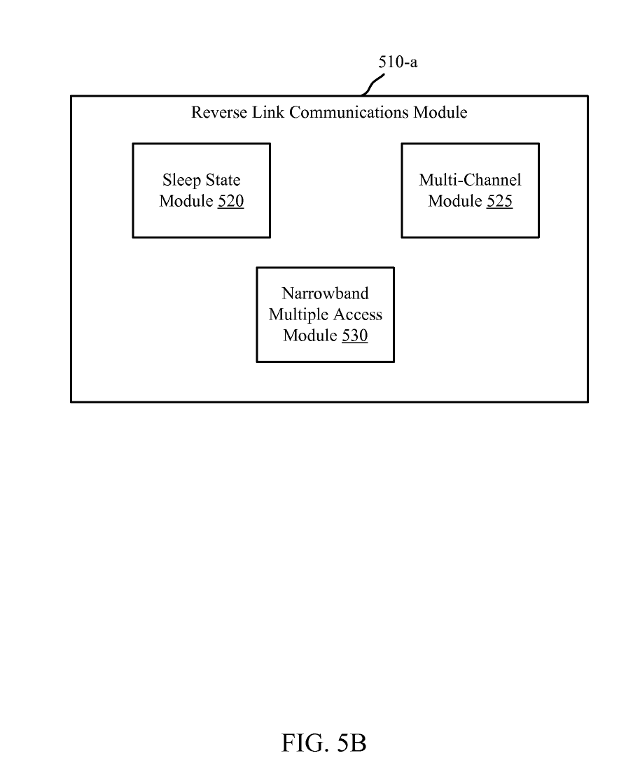

FIG. 5A is a block diagram illustrating a device 500 for managing reverse link communications in accordance with various embodiments. The device 500 may be an example of one or more aspects of the M2M device 115 and/or the base station 105 described with reference to FIGS. 1, 2, 3A, and/or 3B. The device 500 may also be a processor. The device 500 may include a receiver module 505, a reverse link communications module 510, and/or a transmitter module 515. Each of these components may be in communication with each other.

These components of the device 500 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what the device 500 has received or transmitted. The received information may be utilized by the reverse link communications module 510 for a variety of purposes.

The receiver module 505 may be configured to receive a forward link physical layer packet sent from a base station 105 using forward link communications 325. The reverse link communications module 510 may generate a reverse link frame that includes a traffic slot to transmit data from an M2M device 115 to a base station 105.

In one embodiment, the reverse link communications module 510 may cause communications on the reverse link to terminate early. As previously explained, the forward link frame may include an ACK channel to transmit ACK messages from the base station 105 to an M2M device 115 at a high data rate. ACK messages corresponding to higher reverse link data rates may be received by the receiver module 505 at the higher data rate. Upon receiving the ACK message, the reverse link communications module 510 may instruct the transmitter 515 to cease transmitting communications on the reverse link communications 330. Details regarding the reverse link communication module 510 will be described below.

FIG. 5B is a block diagram illustrating one embodiment of a reverse link communications module 510-a. The module 510-a may be an example of the reverse link communications module of FIG. 5A. In one example, the module 510-a may include a sleep state module 520, a multi-channel module 525, and a narrowband multiple access module 530.

In one configuration, the sleep state module 520 may allow an M2M device 115 to wake up long enough to receive a message from a base station 105 and then return to a sleep state to conserve power. The base station may transmit a message to the M2M device using a forward link frame. The frame may include a paging channel to carry the message. The paging channel may include a number of sub-channels. The base station may transmit a copy of the message in each sub-channel. When the M2M device successfully receives and demodulates the message on one of the sub-channels, the sleep state module 520 may cause the M2M device 115 to turn off its radio and return to a sleep state to conserve the battery without sending an ACK message back to the base station.

In one embodiment, the multi-channel module 525 may provide a code division multiple access (CDMA) based multiple access scheme to reduce negative effects of an operating rise over thermal (ROT) noise on the reverse link communications 330. In one configuration, the module 525 may divide the operating band of the reverse link into multiple reverse link frequency channels. Within each frequency channel, the module 525 may use CDMA for multiple user multiplexing. Each frequency channel may have its own target ROT operation point. The multi-channel module 525 may dedicate at least one frequency channel as a low data rate random access channel. As a result, the operating ROT may be reduced.

In one example, the narrowband multiple access module 530 may provide a narrowband frequency division multiple access (FDMA) technique for the reverse link communications 330. The module 530 may divide the operating band into a number of narrowband frequency channels. A busy or idle status of each narrowband channel may be broadcasted to each M2M device 115. The devices may contend for a channel selected randomly from the idle set of channels by sending a preamble. The module 530 may allow the M2M device 115 to transmit data only if a channel is either implicitly or explicitly assigned to the M2M device. The module 530 may not allow the transmission to be interrupted if the channel state changes to busy.

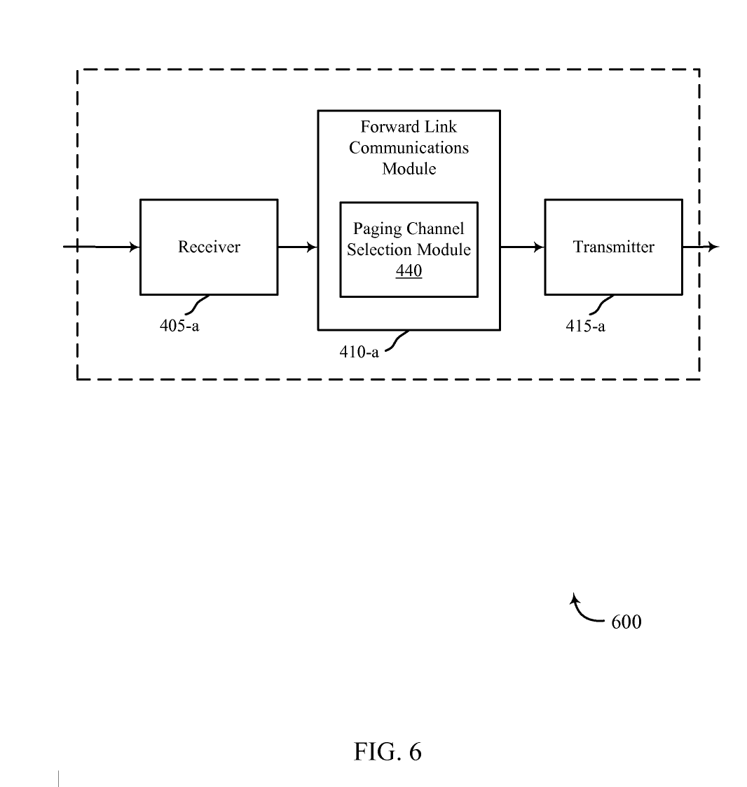

FIG. 6 is a block diagram illustrating a device 600 for managing forward link communications in accordance with various embodiments. The device 600 may be an example of one or more aspects of the base station described with reference to FIGS. 1, 2, 3A, 3B, 4A, and/or 4B. The device 600 may also be a processor. The device 600 may include a receiver module 405-a, a forward link communications module 410-a, and/or a transmitter module 415-a. Each of these components may be in communication with each other.

The components of the device 600 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405-a may receive information such as packet, data, and/or signaling information regarding what the device 600 has received or transmitted. The received information may be utilized by the forward link communications module 410-a for a variety of purposes, as previously described.

In one configuration, the forward link communications module 410-a may include a paging channel selection module 440. The module 440 may dynamically change paging channels used to transmit paging messages. Messages may be transmitted in the different paging channels at different data rates over different paging cycles. Details regarding the selection of a paging channel will be described below.

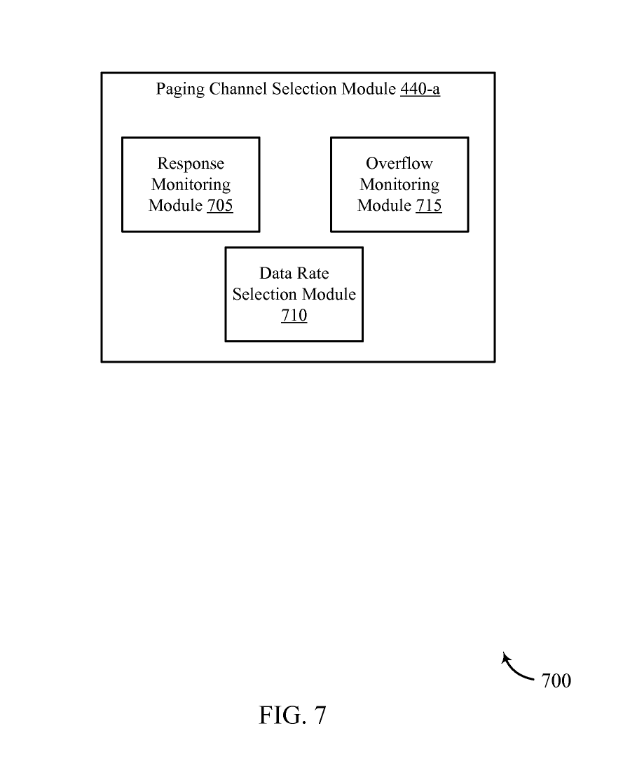

FIG. 7 is a block diagram illustrating one embodiment of a paging channel selection module 440-a. The module 440-a may be an example of the paging channel selection module 440 of FIGS. 4B and/or 6. In one configuration, the module 440-a may include a response monitoring module 705, a data rate selection module 710, and an overflow monitoring module 715.

In one example, the monitoring module 705 may monitor reverse communications 330 for certain messages. In one configuration, the module 705 may monitor communications on the reverse link 330 for a paging response message 310 transmitted from an M2M device 115. The M2M device 115 may transmit the paging response message 310 upon successfully demodulating a paging message 305. The monitoring module 705 may also monitor certain conditions. For example, the module 705 may monitor a temperature condition, a time of day condition, etc. The paging channel selection module 440-a may dynamically change the paging channel used to transmit messages to an M2M device 115 based on the events and conditions monitored by the monitoring module 705.

The data rate selection module 710 may select a data rate to transmit paging messages when the paging channel is changed. For example, the monitoring module 705 may detect that a paging response have not been received from an M2M device 115 following a certain time period that a paging message was transmitted to the device 115. The paging message may have been transmitted at a first data rate using a first paging channel. The selection module 440-a may select a different paging channel to use to retransmit the paging message. The data rate selection module 710 may select a second data rate to use to transmit the message on the second paging channel. In addition to dynamically changing the paging channel (and the data rate) used to transmit paging messages, the paging cycle may also be changed. In one configuration, when a paging response is not received at the base station 105, the paging message may be retransmitted at a lower data rate and at a shorter duty cycle. The base station 105 may generate a message to notify the devices 115 of the change in the cycle. In one embodiment, the device 115 and base station 105 may not exchange messages regarding a change in the paging cycle. The change in paging cycle may be predetermined and known in advance at the base station 105 and the device 115. Information regarding certain conditions (e.g., time of day, environmental conditions, etc.) may be known by the device 115 and the base station 105. As a result, when a certain condition triggers a change to the data rate and paging cycle, the device 115 and base station 105 may dynamically change the cycle without engaging in additional messaging.

The overflow monitoring module 715 may monitor paging messages to determine whether additional paging slots are needed to transmit the messages. In some cases, a paging message may be too large to be transmitted in a single paging slot. As a result, part of the paging message may overflow into additional paging slots of other frames. The paging message may include a header that includes an overflow bit. The module 715 may set the overflow bit in the message header to indicate to the M2M device 115 that is mapped to read the current paging slot that the device 115 should continue reading subsequent paging slots until the overflow bit is reset.

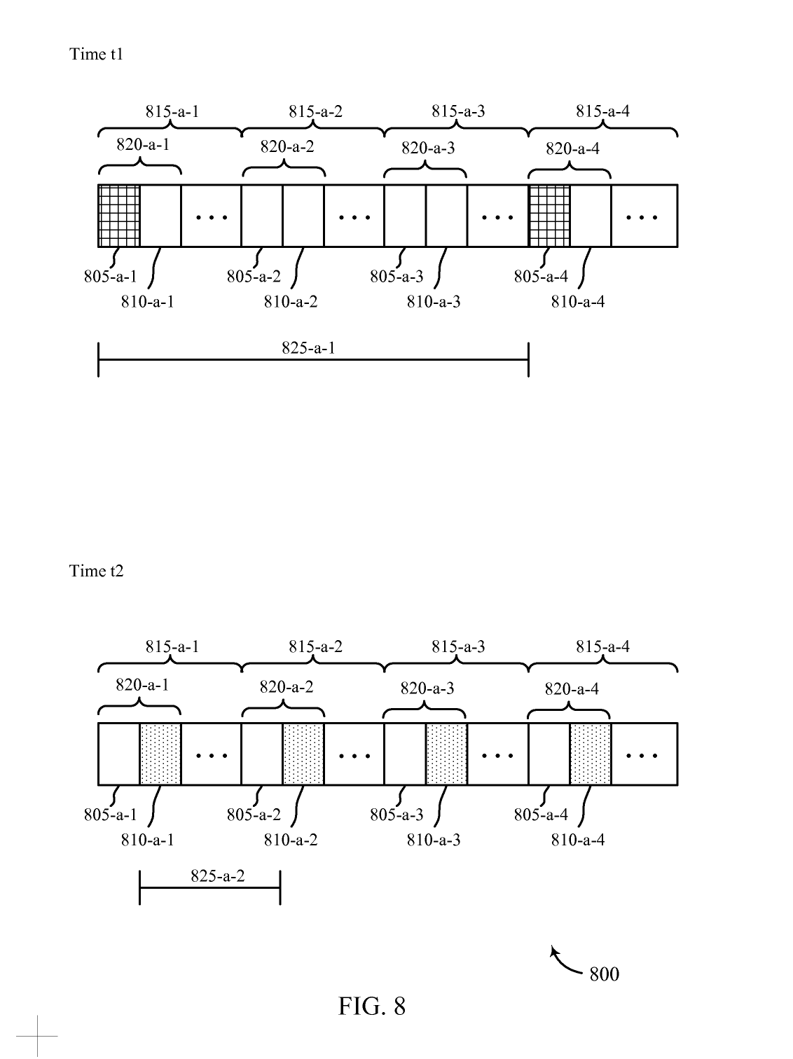

FIG. 8 illustrates one example 800 of dynamically selecting different paging channels to use when transmitting paging messages at different data rates and different paging cycles in accordance with the present systems and methods. In one embodiment, multiple forward link frames 815 may each include a paging slot 820. Each frame 815 may include other slots in addition to the paging slot 820. In one embodiment, each frame 815 may include an ACK slot, a traffic slot, etc. In one configuration, the paging slot 820 may include sub-channels 805, 810 to use when transmitting paging messages. For example, a first frame 815-a-1 may include a first paging slot 820-a-1 that includes a first paging channel 805-a-1 and a second paging channel 810-a-1. At a first time t1, a paging message may be transmitted in the first paging channel 805-a-1 according to a first paging cycle 825-a-1.

As illustrated in the example at time t1, for a specific device, a paging message, targeted for that device, may be transmitted every third frame using the first paging channel 805. In this example, the paging message may be transmitted during the first paging slot 820-a-1 of the first frame 815-a-1 using a first paging channel 805-a-1. A paging message may then be transmitted during a fourth paging slot 820-a-4 of a fourth frame 815-a-4 using a first paging channel 805-a-4. A paging message may not be transmitted during the second paging slot 820-a-2 and the third paging slot 820-a-3. The paging message transmitted during the first paging slot 820-a-1 of the first frame 815-a-1 may be the same as the paging message transmitted during paging slots of later frames. The paging messages transmitted during the paging slots 820 of different frames 815 may be different. In this example, the first paging cycle 825-a-1 at time t1 may indicate that paging messages are to be transmitted every third forward link frame using the first paging channel 805 of the corresponding paging slots. Paging messages transmitted using the first paging channel 805 may be transmitted at a high data rate. For example, the messages may be transmitted at 20 kilo bits per second (kbps).

In one configuration, at a time t2, the paging channel used to transmit the paging messages may dynamically change. In one example, the time t2 may be subsequent to the time t1. In one embodiment, the first paging cycle 825-a-1 may change to a second paging cycle 825-a-2 where paging messages are now transmitted during each paging slot 820 of each forward link frame 815. The paging messages transmitted at the second paging cycle 825-a-2 may be transmitted at a lower data rate than the data rate used to transmit the paging messages at the first paging cycle 825-a-1. In one example, a second paging channel 810 may be used to transmit paging messages at a lower data rate and at a shorter paging cycle. The second paging channel 810 may be a sub-channel of the paging slot 820. The paging messages may be transmitted using the second paging channel 810 at 10 kbps.

The paging message transmitted during the second paging cycle 825-a-2 at time t2 may be the same message that was transmitted during the first paging cycle 825-a-1 at time t1. Alternatively, the paging messages transmitted during the second paging cycle 825-a-2 may be different than the paging messages transmitted during the first paging cycle 825-a-1. In addition to transmitting a paging message more often during the second paging cycle 825-a-2, the modulation and coding schemes applied to the messages may also be different than the schemes applied to the messages transmitted during the first paging cycle 825-a-1. Further, the data rate used to transmit messages during the first paging cycle 825-a-1 may be higher than the data rates used to transmit the paging messages during the second paging cycle 825-a-2.

In one embodiment, a bit may be set in a frame prior to a frame during which a paging message is transmitted. For example, a bit may be set in the frame prior to the first frame 815-a-1. If the bit is set in the prior frame, an M2M device 115 may be put on notice that during the next frame (e.g., the first frame 815-a-1) a paging message may be transmitted.

In one configuration, a paging message may be transmitted to an M2M device 115 at time t1 using the first primary channel 805 of the first paging slot 820-a-1 and the fourth paging slot 820-a-4. The paging message may be transmitted at a high data rate (e.g., 20 kbps) according to the first paging cycle 825-a-1 and. The base station 105 that transmits the paging message may monitor for a paging response message. Upon failing to receive the response message, the base station may retransmit the paging message at a lower data rate (e.g., 10 kbps) according to the second paging cycle 825-a-2. The retransmissions of the paging message may be done using the second paging channel 810. Upon receiving a response message, the base station 105 may resume transmitting future paging messages to the M2M device 115 at the higher data rate using the first paging channel 805 in accordance with the first paging cycle 825-a-1.

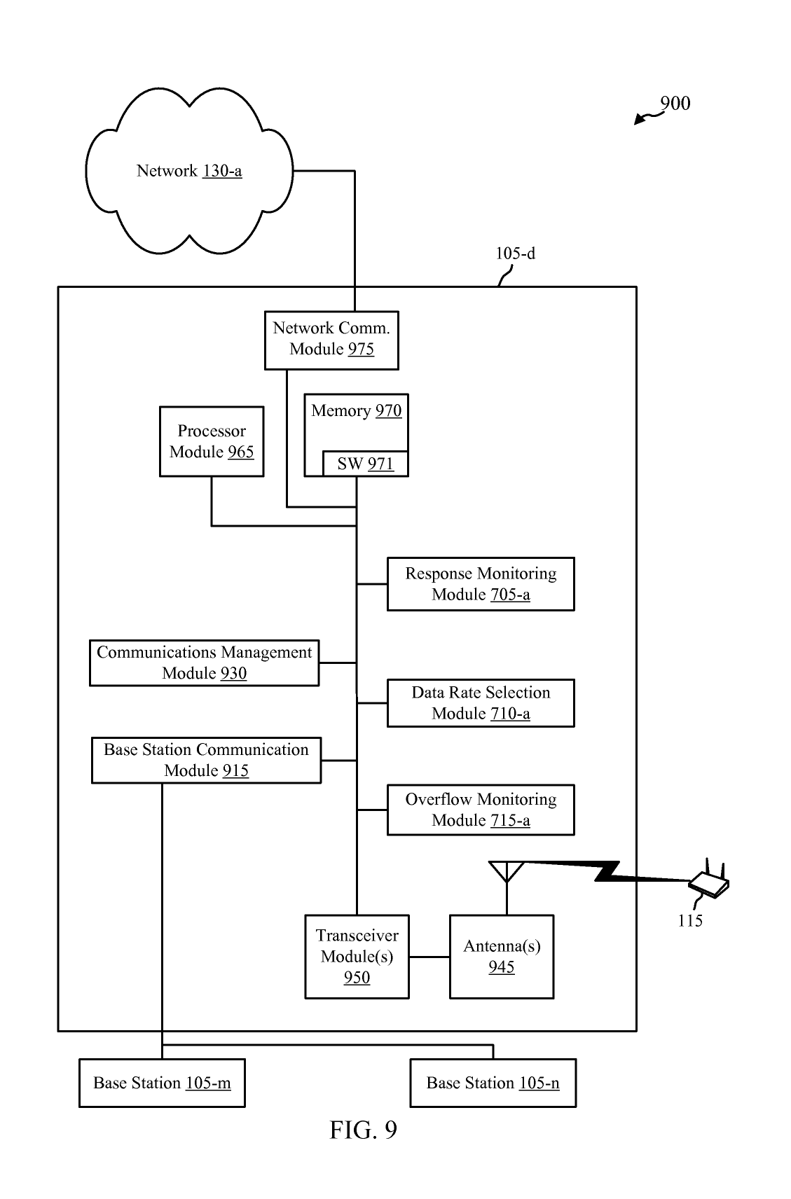

FIG. 9 shows a block diagram of a communications system 900 that may be configured for dynamically altering a data rate at which paging messages are transmitted to M2M devices 115 in accordance with various embodiments. This system 900 may be an example of aspects of the system 100 depicted in FIG. 1, system 200 of FIG. 2, system 300 of FIG. 3A, 320 of FIG. 3B, system 400 of FIG. 4A, and/or system 600 of FIG. 6.

The system 900 may include a base station 105-d. The base station 105-d may include antennas 945, a transceiver module 950, memory 970, and a processor module 965, which each may be in communication, directly or indirectly, with each other (e.g., over one or more buses). The transceiver module 950 may be configured to communicate bi-directionally, via the antennas 945, with an M2M device 115, which may be a sensor, meter, or any other type of device capable of tracking, sensing, monitoring, etc. The transceiver module 950 (and/or other components of the base station 105-d) may also be configured to communicate bi-directionally with one or more networks. In some cases, the base station 105-d may communicate with the core network 130-a through network communications module 975.

Base station 105-d may also communicate with other base stations 105, such as base station 105-m and base station 105-n. Each of the base stations 105 may communicate with the M2M device 115 using different wireless communications technologies, such as different Radio Access Technologies. In some cases, base station 105-d may communicate with other base stations such as 105-m and/or 105-n utilizing base station communication module 915. In some embodiments, base station 105-d may communicate with other base stations through the controller 120 and/or core network 130-a.

The memory 970 may include random access memory (RAM) and read-only memory (ROM). The memory 970 may also store computer-readable, computer-executable software code 971 containing instructions that are configured to, when executed, cause the processor module 965 to perform various functions described herein (e.g., dynamic data rate schemes, flexible paging schemes, ACK schemes, data traffic schemes, etc.). Alternatively, the software 971 may not be directly executable by the processor module 965 but may be configured to cause the computer, e.g., when compiled and executed, to perform functions described herein.

The processor module 965 may include an intelligent hardware device, e.g., a central processing unit (CPU) such as those made by Intel® Corporation or AMD®, a microcontroller, an application-specific integrated circuit (ASIC), etc. The transceiver module 950 may include a modem configured to modulate packets for the M2M device 115 and provide the modulated packets to the antennas 945 for transmission, and to demodulate packets received from the antennas 945. While some examples of the base station 105-d may include a single antenna 945, the base station 105-d preferably includes multiple antennas 945 for multiple links which may support carrier aggregation. For example, one or more links may be used to support macro communications with the M2M device 115.

According to the architecture of FIG. 9, the base station 105-d may further include a communications management module 930. The communications management module 930 may manage communications with other base stations 105. By way of example, the communications management module 930 may be a component of the base station 105-d in communication with some or all of the other components of the base station 105-d via a bus. Alternatively, functionality of the communications management module 930 may be implemented as a component of the transceiver module 950, as a computer program product, and/or as one or more controller elements of the processor module 965.

The components for base station 105-d may be configured to implement aspects discussed above with respect to device 700 in FIG. 7 and may not be repeated here for the sake of brevity. For example, the base station 105-d may include a response monitoring module 705-a, a data rate selection module 710-a, and an overflow monitoring module 715-a. These modules may be examples of the modules previously described with respect to FIG. 7. In one embodiment, the modules 705-a, 710-a, 715-a, may be standalone modules or may be incorporated within the paging channel selection module 440 described in FIGS. 4B, 6, and 7. In addition, some of the modules may be standalone while other may be incorporated as part of the paging channel selection module 440.

In some embodiments, the transceiver module 950 in conjunction with antennas 945, along with other possible components of base station 105-d, may transmit a number of forward link frames that each include a paging slot 805, from the base station 105-d to the M2M device 115, to other base stations 105-m/105-n, or core network 130-a.

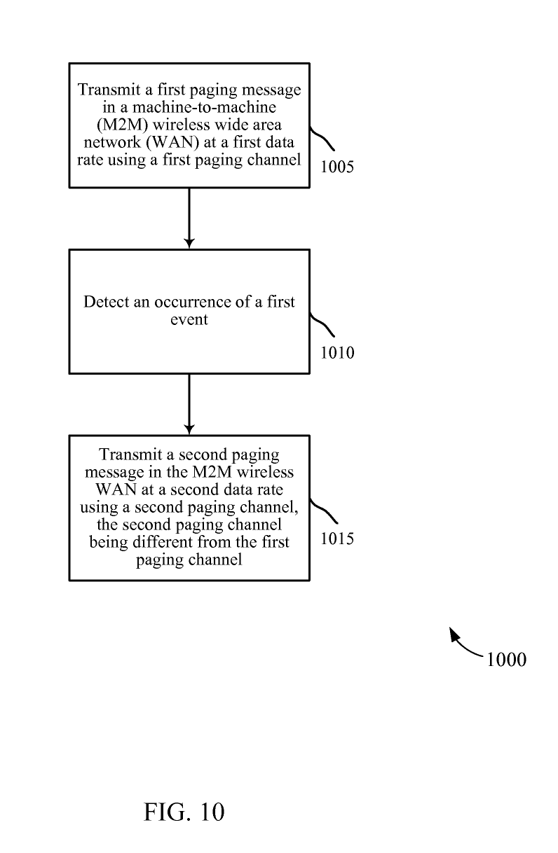

FIG. 10 is a flow chart illustrating one example of a method 1000 for managing forward link communications using multiple paging channels. For clarity, the method 1000 is described below with reference to the base station 105 shown in FIG. 1, 2, 3A, 3B, 4A, 6, or 9. In one implementation, the paging channel selection module 440 may execute one or more sets of codes to control the functional elements of the base station 105 to perform the functions described below.

At block 1005, a first paging message may be transmitted in an M2M wireless WAN. The first paging message may be transmitted at a first data rate using a first paging channel. The first data rate may be, but is not limited to, 20 kbps. The first paging channel may be sub-channel of a paging slot of a forward link frame. At block 1015, an occurrence of a first event may be detected. For example, the non-receipt of a response message may be detected after the first paging message has been transmitted.

At block 1015, a second paging message may be transmitted. The second paging message may be transmitted according to a second data rate using a second paging channel. In one embodiment, the second paging channel may be different than the first paging channel. As a result, the second data rate may be different than the first data rate. The second paging message may be the same (i.e., retransmission) as the first paging message. Conversely, the first and second paging messages may be different. The first paging message may be transmitted according to a first paging cycle while the second paging message may be transmitted according to a second paging cycle. The second paging cycle may be shorter than the first paging cycle.

In one configuration, the first and second paging messages may be transmitted from the same base station. In another example, the first paging message may be transmitted from a first base station, and the second paging message may be transmitted from a second base station that is different than the first base station. The first paging message may be transmitted according to a first paging cycle for a first terminal, such as an M2M device 115. Similarly, the second paging message may be transmitted according to a second paging cycle for the first terminal. In one embodiment, the first paging message may be transmitted according to the first paging cycle for the first terminal, but the second paging cycle may be transmitted according to the second paging cycle for a second terminal (e.g., a second M2M device 115). The second terminal may be different than the first terminal.

Therefore, the method 1000 may provide for efficient communications on the forward link by dynamically changing data rates by using different paging channels to transmit paging messages. The paging channels may change upon detecting the non-receipt of a response that indicates the paging message was received. It should be noted that the method 1000 is just one implementation and that the operations of the method 1000 may be rearranged or otherwise modified such that other implementations are possible.

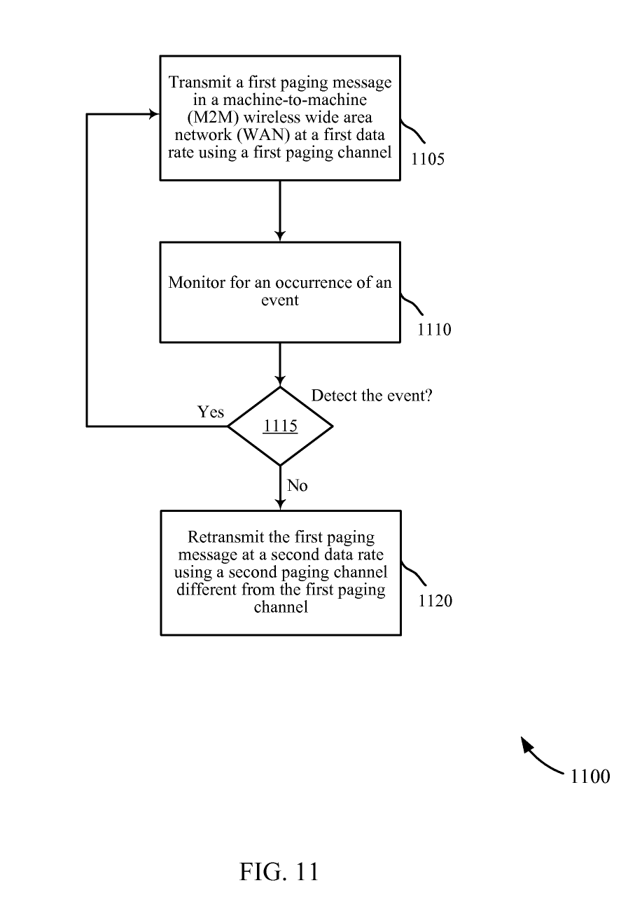

FIG. 11 is a flow chart illustrating one example of a method 1100 for managing forward link communications through dynamic selection of paging channels of a paging slot. For clarity, the method 1100 is described below with reference to the base station 105 shown in FIG. 1, 2, 3A, 3B, 4A, 6, or 9. In one implementation, the paging channel selection module 440 may execute one or more sets of codes to control the functional elements of the base station 105 to perform the functions described below.

At block 1105, a first paging message may be transmitted in a M2M wireless WAN at a first data rate using a first paging channel. At block 1110, the occurrence of an event may be monitored. A determination may be made at block 1115 as to whether the occurrence of the event has been detected. In one embodiment, the event may include the receipt of a response from an M2M device 115 indicating that the M2M device 115 had successfully received the first paging message. If it is determined at block 1115 that the event is detected (e.g., receipt of a paging message response), the method 1100 may return to block 1105 to continue transmitting a paging message at the first data rate using the first paging channel. The first message may be transmitted according to a first paging cycle. If, however, it is determined at block 1115 that the event has not occurred (e.g., non-receipt of a response to the paging message), at block 1120, the first paging message may be retransmitted at a second data rate using a second paging channel. The second paging channel may be different than the first paging channel. In one configuration, when a response to the first paging message is not received, the paging cycle may be shortened and the paging message may be retransmitted at a lower data rate according to the shortened paging cycle.

Therefore, the method 1100 may provide for efficient communications on the forward link by dynamically changing the data rate used to transmit a paging message if a paging response is not received. It should be noted that the method 1100 is just one implementation and that the operations of the method 1100 may be rearranged or otherwise modified such that other implementations are possible.

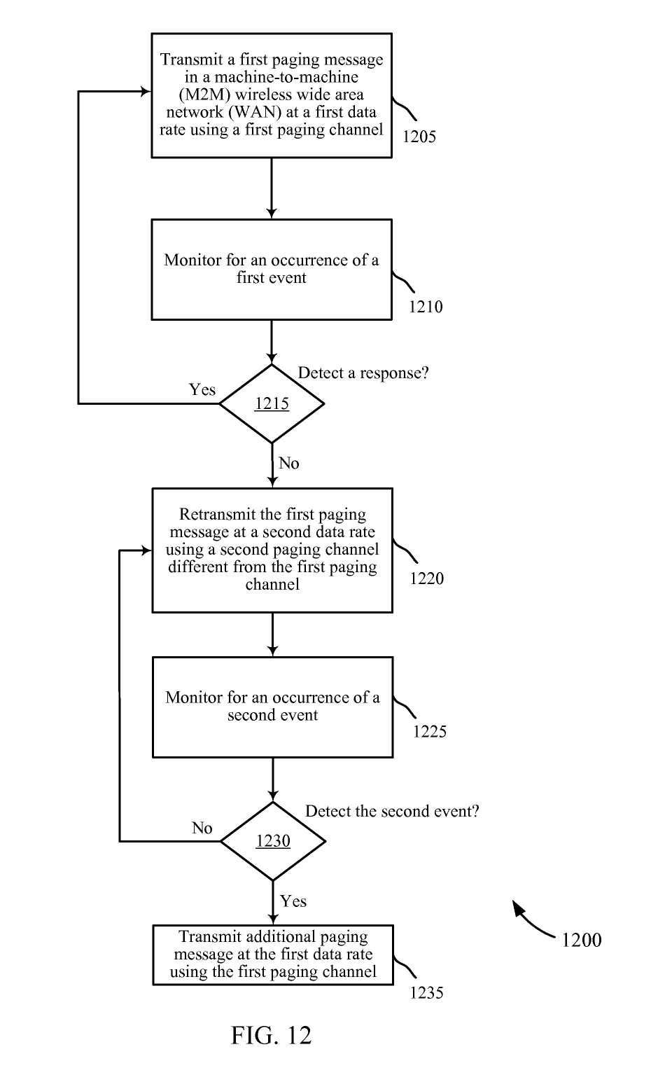

FIG. 12 is a flow chart illustrating one example of a method 1200 for managing forward link communications by implementing a dynamic selection of a paging channel for the transmission of paging messages. For clarity, the method 1200 is described below with reference to the base station 105 shown in FIG. 1, 2, 3A, 3B, 4A, 6, or 9. In one implementation, the paging channel selection module 440 may execute one or more sets of codes to control the functional elements of the base station 105 to perform the functions described below.

At block 1205, a first paging message may be transmitted to an M2M device 115 in a M2M wireless WAN at a first data rate using a first paging channel. The first paging message may be transmitted according to a first paging cycle. The first paging message may inform the M2M device 115 that it needs to contact the base station 105 to report its status, to prepare to receive additional data from the base station 105, or for some other purpose. The first paging message may be transmitted during a paging slot of a frame on the forward link communication.

At block 1210, the occurrence of an event may be monitored. A determination may be made at block 1215 as to whether the occurrence of the event has been detected. In one embodiment, the event may include the receipt of a response from an M2M device 115 indicating that the M2M device 115 had successfully received the first paging message. The event may also be the non-occurrence of a state change, such as, a certain time of day, a certain temperature or other environmental conditions, etc.

If it is determined at block 1215 that the event is detected (e.g., receipt of a paging message response, no state change, etc.), the method 1200 may return to block 1205 to continue transmitting a paging message at the first data rate according to the first paging cycle. If, however, it is determined at block 1215 that the event has not occurred (e.g., non-receipt of a response to the paging message, state change, etc.), at block 1220, the first paging message may be retransmitted at a second data rate using a second paging channel. The message may be retransmitted at a second paging cycle, which may be shorter than the first paging cycle. In addition, the second data rate may be lower than the first data rate.

At block 1225, the occurrence of a second event may be monitored. The second event may include the receipt of a response to the paging message, the expiration of a predetermined period of time, etc. At block 1230, a second determination is made as to whether the second event has been detected. If it is determined at block 1230 that the second event has not been detected, the method 1200 may return to continue to retransmit the first paging message at the second data rate according to the second paging cycle. If, however, it is determined at block 1230 that the second event has been detected, at block 1235, additional paging messages may be transmitted at the first data rate according to the first paging cycle.

Therefore, the method 1200 may provide for efficient communications on the forward link by altering the data rate of transmitted paging messages based on the occurrence of an event and then returning to transmit messages at the original data rate upon the occurrence of another event. It should be noted that the method 1200 is just one implementation and that the operations of the method 1200 may be rearranged or otherwise modified such that other implementations are possible.

Techniques described herein may be used for various wireless communications systems such as M2M systems, cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies for multiple access in a wireless system such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication in a machine-to-machine (M2M) wireless Wide Area Network (WAN), comprising:
transmitting a first paging message in the M2M wireless WAN at a first data rate using a first paging channel;
detecting an occurrence of a first event; and
transmitting a second paging message, based at least in part on the occurrence of the first event, at a second data rate using a second paging channel, the second paging channel being different from the first paging channel.

2. The method of claim 1, wherein the first paging message and the second paging message comprise a same message.

3. The method of claim 1, wherein the second data rate is lower than the first data rate.

4. The method of claim 1, wherein detecting the occurrence of the first event further comprises:
detecting a non-receipt of a response after a period of time following the transmission of the first paging message at the first data rate.

5. The method of claim 1, further comprising:
detecting an occurrence of a second event; and
transmitting a third paging message at the first data rate using the first paging channel.

6. The method of claim 5, wherein detecting the occurrence of the second event further comprises:
detecting a receipt of a response indicating a receipt of the second paging message at the second data rate.

7. The method of claim 1, wherein the first paging channel and the second paging channel comprise a logical channel.

8. The method of claim 1, further comprising:
transmitting the first paging message according to a first paging cycle; and
transmitting the second paging message according to a second paging cycle.

9. The method of claim 8, wherein the first paging cycle comprises a first length and the second paging cycle comprises a second length, the second length being shorter than the first length.

10. The method of claim 1, further comprising:
retransmitting the first paging message at the second data rate until a response is received indicating receipt of the first paging message.

11. The method of claim 1, further comprising:
transmitting the first paging message and the second paging message concurrently, the transmission of the first paging message using the first paging channel and the transmission of the second paging message using the second paging channel.

12. The method of claim 1, wherein transmitting the first paging message and the second paging message further comprises:
transmitting the first paging message from a first base station; and
transmitting the second paging message from the first base station.

13. The method of claim 1, wherein transmitting the first paging message and the second paging message further comprises:
transmitting the first paging message from a first base station; and
transmitting the second paging message from a second base station, the second base station being different than the first base station.

14. The method of claim 1, further comprising:
identifying a time slot of a physical layer frame; and
transmitting a paging message during the identified time slot.

15. The method of claim 14, wherein identifying the time slot further comprises:
executing a hashing function to determine the time slot; and
assigning the time slot to a terminal, the time slot comprising the paging message.

16. The method of claim 1, wherein the first paging channel and the second paging channel comprise a code division multiple access (CDMA) channel.

17. The method of claim 1, wherein the first paging channel and the second paging channel comprise a time division multiple access (TDMA) channel.

18. A base station configured for wireless communication in a machine-to-machine (M2M) wireless Wide Area Network (WAN), comprising:
a processor;
memory in electronic communication with the processor; and
instructions stored in the memory, the instructions being executable by the processor to:
transmit a first paging message in the M2M wireless WAN at a first data rate using a first paging channel;
detect an occurrence of a first event; and
transmit a second paging message, based at least in part on the occurrence of the first event, at a second data rate using a second paging channel, the second paging channel being different from the first paging channel.

19. The base station of claim 18, wherein the first paging message and the second paging message comprise a same message.

20. The base station of claim 18, wherein the second data rate is lower than the first data rate.

21. The base station of claim 18, wherein the instructions to detect the occurrence of the first event are further executable by the processor to:
detect a non-receipt of a response after a period of time following the transmission of the first paging message at the first data rate.

22. The base station of claim 18, wherein the instructions are further executable by the processor to:
detect an occurrence of a second event; and
transmit a third paging message at the first data rate using the first paging channel.

23. The base station of claim 22, wherein the instructions to detect the occurrence of the second event are further executable by the processor to:
detect a receipt of a response indicating a receipt of the second paging message at the second data rate.

24. The base station of claim 18, wherein the first paging channel and the second paging channel comprise a logical channel.

25. The base station of claim 18, wherein the instructions to transmit the first paging message and the second paging message are further executable by the processor to:
transmit the first paging message according to a first paging cycle; and
transmit the second paging message according to a second paging cycle.

26. The base station of claim 25, wherein the first paging cycle comprises a first length and the second paging cycle comprises a second length, the second length being shorter than the first length.

27. The base station of claim 18, wherein the instructions are further executable by the processor to:
retransmit the first paging message at the second data rate until a response is received indicating receipt of the first paging message.

28. An apparatus configured for wireless communication in a machine-to-machine (M2M) wireless Wide Area Network (WAN), comprising:
means for transmitting a first paging message in the M2M wireless WAN at a first data rate using a first paging channel;
means for detecting an occurrence of a first event; and
means for transmitting a second paging message, based at least in part on the occurrence of the first event, at a second data rate using a second paging channel, the second paging channel being different from the first paging channel.

29. The apparatus of claim 28, wherein the first paging message and the second paging message comprise a same message.

30. The apparatus of claim 28, wherein the second data rate is lower than the first data rate.

31. The apparatus of claim 28, wherein the means for detecting the occurrence of the first event further comprise:
means for detecting a non-receipt of a response after a period of time following the transmission of the first paging message at the first data rate.

32. The apparatus of claim 28, further comprising:
means for detecting an occurrence of a second event; and
means for transmitting a third paging message at the first data rate using the first paging channel.

33. The apparatus of claim 28, wherein the means for transmitting the first paging message and the second paging message further comprise:
means for transmitting the first paging message according to a first paging cycle; and
means for transmitting the second paging message according to a second paging cycle.

34. The apparatus of claim 33, wherein the first paging cycle comprises a first length and the second paging cycle comprises a second length, the second length being shorter than the first length.

35. The apparatus of claim 28, further comprising:
retransmit the first paging message at the second data rate until a response is received indicating receipt of the first paging message.

36. The apparatus of claim 28, further comprising:
means for transmitting the first paging message and the second paging message concurrently, the transmission of the first paging message using the first paging channel and the transmission of the second paging message using the second paging channel.

37. The apparatus of claim 28, further comprising:
means for transmitting the first paging message from a first base station; and
means for transmitting the second paging message from the first base station.

38. The apparatus of claim 28, further comprising:
means for identifying a time slot of a physical layer frame; and
means for transmitting a paging message during the identified time slot.

39. The apparatus of claim 38, wherein the means for identifying the time slot further comprise:
means for executing a hashing function to determine the time slot; and
means for assigning the time slot to a terminal, the time slot comprising the paging message.

40. A computer program product for managing wireless communication in a machine-to-machine (M2M) wireless Wide Area Network (WAN), the computer program product comprising a non-transitory computer-readable medium storing instructions executable by a processor to:
transmit a first paging message in the M2M wireless WAN at a first data rate using a first paging channel;
detect an occurrence of a first event; and
transmit a second paging message, based at least in part on the occurrence of the first event, at a second data rate using a second paging channel, the second paging channel being different from the first paging channel.

41. The computer program product of claim 40, wherein the first paging message and the second paging message comprise a same message.

42. The computer program produce of claim 40, wherein the second data rate is lower than the first data rate.
